(19) United States
(12) Patent Application Publication
(10) Pub. No.: US 2022/0220652 A1
(43) Pub. Date: Jul. 14, 2022

(54) Dryer Terminal And Terminal Block Interface

(71) Applicant: Whirlpool Corporation, Benton Harbor, MI (US)

(72) Inventors: James CAMPBELL, Waldo, OH (US); Thomas MCNAMARA, Delaware, OH (US); George SEIFFERT, Benton Harbor, MI (US)

(21) Appl. No.: 17/145,709

(22) Filed: Jan. 11, 2021

(51) Int. Cl. D06F 34/10; H01R 13/506; H01R 13/512

(52) U.S. Cl. CPC D06F 34/10; H01R 13/512; H01R 13/506

(57) ABSTRACT

A terminal block and terminal assembly where the terminal block has a base and at least one terminal receiving area. The at least one terminal receiving area includes a floor and a pair of opposing sidewalls extending substantially perpendicular to the floor to define a channel. At least one tab projects from one of the pair of opposing walls and extends toward the other wall. The terminal has a base with a wire connector portion at one end and a locking mechanism at the other end. The locking mechanism has a portion to receive the at least one tab so that the tab is sandwiched by the locking mechanism to lock the terminal against tipping in the terminal receiving area.

### FIELD

The present disclosure relates to dryer appliances, more particularly, to a dryer terminal block and terminal with an interlocking design.

### BACKGROUND

In a dryer appliance, an electric terminal block is utilized to receive power wires. The terminal block is, in turn, secured to an appliance electrical system or the like. During the attachment of the wires, the terminals must be held in place so that a technician can secure the wires, via the terminals, to the terminal block. It is important during attachment of the terminals to the terminal blocks, that the terminal is steadied or locked in position during the assembly process. Thus, the terminal block and terminal assembly can be secured with the dryer electronics during the installation process.

Accordingly, it is desirable to hold the terminals, during installation of the wires onto the terminal block, against longitudinal movement, lateral movement as well as tipping or pitch movement. Thus, it is desirable to eliminate these three directional elements to enhance efficient and accurate assembly of the terminals with the terminal block.

Various types of assemblies exist to hold the terminals in the terminal block during the installation process. While these different types of assemblies appear to work satisfactory for their intended purposes, designers are striving to improve the art and provide new and useful designs.

The present disclosure provides the art with a terminal and terminal block locking interface that prohibits movement of the terminal in the block during installation of the terminal in the terminal block. The present disclosure eliminates longitudinal movement, lateral movement as well as up and down tipping or pitch movement of the terminal during the installation process. This enables an accurate and efficient attachment of the terminal in the terminal block as well as with the dryer electronics.

### SUMMARY

This section provides a general summary of the disclosure, and is not a comprehensive disclosure of its full scope or all of its features.

It is an object of the present disclosure to provide a terminal block and a terminal that comprises a terminal block including a base with at least one terminal receiving area. The at least one tab receiving area, of which there are multiple, includes a floor and a pair of opposing sidewalls extending substantially perpendicular to the floor to define a channel. At least one tab projects from one of the pair of opposing walls and extends toward the other wall. The terminal includes a base with a wire connector portion at one end and a locking mechanism at the other end. The locking mechanism includes a portion to receive the at least one tab so that the tab is sandwiched by the locking mechanism locking the terminal in the terminal receiving area.

The locking mechanism portion includes a cutout to receive the at least one tab. The at least one tab is preferably a pair of tabs, one positioned on each of the opposing walls. Likewise, the terminal includes a pair of cutouts. The locking mechanism includes an angular portion angling away from the base. The angular portion include at least one arm to engage the at least one tab. The arm may include a detent to engage the at least one tab.

According to a second embodiment, a terminal block and a terminal comprises a terminal block including a base, with a terminal retention mechanism and at least one terminal receiving area. The at least one terminal receiving area includes a floor and a pair of opposing walls that extends substantially parallel to the floor to define a channel. At least one tab projects from one of the pair of opposing walls extending toward the other wall. A pair of terminal lock members are positioned on each wall of the pair of opposing walls. The pair of terminal lock members oppose one another and are spaced from the floor to provide a gap to receive the terminal. The terminal includes a base with a wire connector portion at one end and a locking mechanism at the other. The base includes a projecting finger adjacent to the wire connector portion. The projecting finger and pair of terminal lock members prevent longitudinal and lateral movement of the terminal in the channel of the terminal receiving area. The locking mechanism engages the at least one tab to prevent tipping or pitch movement of the terminal. The locking mechanism includes a portion engaging the tab to prevent pitch movement. The locking mechanism includes a cutout to receive the at least one tab. Preferably there are a pair of tabs as well as a pair of cutouts. The locking mechanism includes an angled portion angling away from the base. The angled portion includes at least one arm to engage the at least one tab. The arm may include a detent to engage the at least one tab.

According to a third embodiment of the present disclosure, a terminal block and terminal comprises a terminal block including a plurality of terminal receiving areas and at least one terminal. The plurality of terminal receiving areas each include a floor and a pair of opposing walls that extend substantially perpendicular to the floor to define a channel. A pair of tabs are positioned on the opposing walls and extend toward one other in the terminal receiving area. The terminal includes a base with a wire connector portion and a locking mechanism. The locking mechanism includes a portion engaging the tab to prevent pitch movement of the terminal. The locking mechanism includes a cutout to receive the pair of tabs. Preferably, there are a pair of cutouts. The locking mechanism includes an angled portion angling away from the base. The angled portion includes a pair of arms to engage the tabs. The arms may include a detent to engage the tab.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a terminal block as installed to a dryer.

FIG. 2 is a top plan view of FIG. 1.

FIG. 3A is a cross-section view partially in perspective of FIG. 1.

FIG. 3B is an enlarged view of FIG. 3A.

FIG. 4 is an exploded view of FIG. 3A.

FIG. 5 is a perspective enlarged view of a second embodiment of the disclosure.

### DETAILED DESCRIPTION

Example embodiments will now be described more fully with reference to the accompanying drawings.

Turning to the figures, a terminal block assembly is illustrated and designated with the reference numeral 10. The terminal block assembly 10 includes a terminal block 12 and one or more terminals 14. The terminal block 12 includes a retention member 16 that enables securement of the terminal block 12 to a support 18. Generally, the retention member 16 includes an aperture 20 that receives a fastener (not shown) to pass through the terminal block 12 to retain it on the support 18.

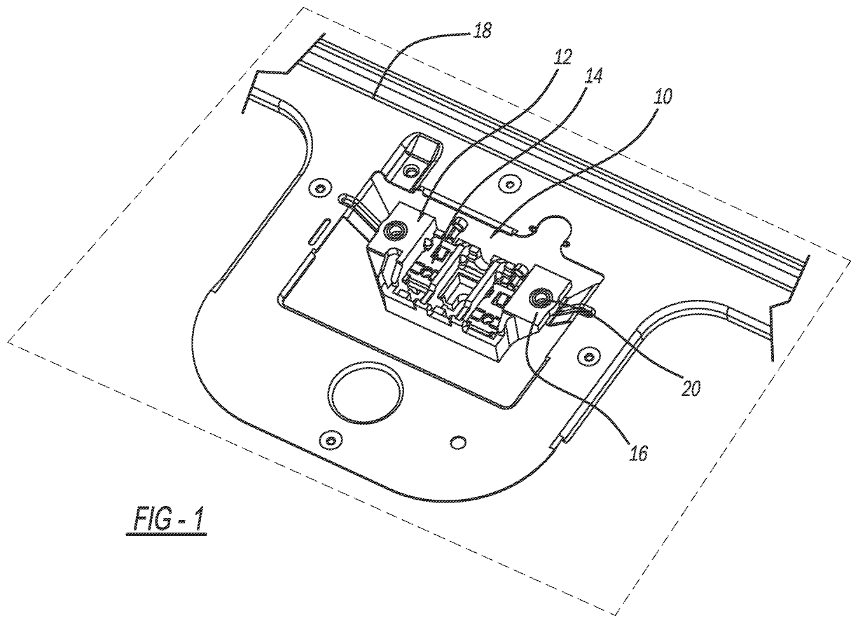

The terminal block base 12 includes at least one terminal receiving area 22, three are illustrated in FIG. 1. The terminal receiving area 22 receives the terminal 14. The terminal receiving area 22 includes a floor 24 with a pair of opposing sidewalls 26. The pair of opposing sidewalls 26 are substantially perpendicular to the floor 24 and define a channel to receive the terminal 14.

At the rear of the terminal receiving area 22, a pair of terminal lock members 28 project from the walls 26. Generally, the pair of lock members 28 oppose one another and are located over an aperture 30 in the terminal block 12.

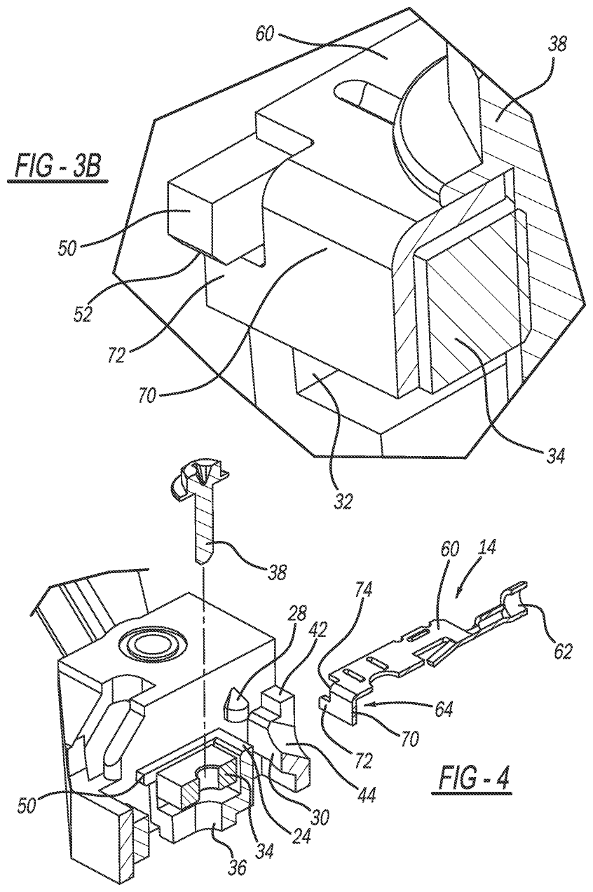

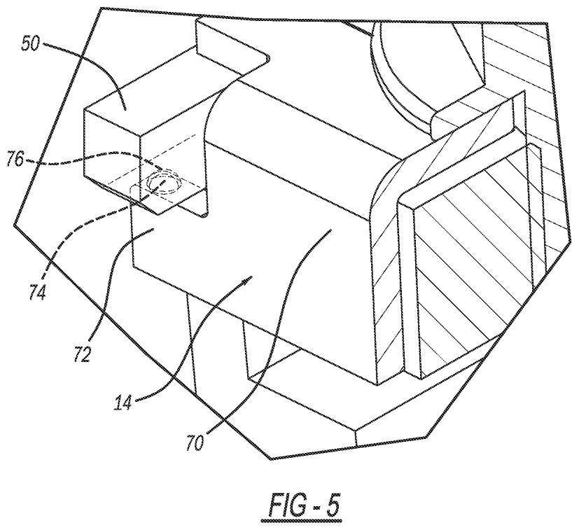

The floor 24 defines a recess 32 that receives a block 34 secured to the terminal 14. A slot 36 is formed at the bottom of the recess 32 to enable a fastener 38 to pass through the terminal 14 and block 34 to secure with the terminal block 12, as seen in FIG. 3. Also, the terminal block 12 includes a rear wall 42 that includes a cutout 44 to receive the wire securement portion 62 of the terminal 14. The front of the terminal block receiving area 22 includes an opening 48 that enables positioning of the terminal 14 and sliding of the terminal 14 as will be described herein.

A pair of tabs 50 project from the sidewalls 26 of the terminal receiving area 22. The tabs 50 can be of any desired configuration as illustrated having an overall rectangular design. The tabs 50 receive the electrical terminal 14 as will be described herein. Generally the tabs 50 include an angled or tapered surface 52 to enable easy insertion of the terminal 14 onto the tabs 50.

The terminal 14 includes a base 60 with a wire connecting portion 62 and a locking mechanism 64. The base 60 is generally planar and includes an aperture 66 to receive the fastener 38 to secure the terminal 14 to the terminal block 12. The terminal 14 also includes a projecting finger 68 adjacent to the wire connector portion 62. The finger 68 engages the floor wall to prohibit longitudinal sliding movement forward once the terminal 14 is in a to be connected position, as will be described later.

The locking mechanism 64 includes an angled portion 70 angling away from the base 60. Generally, the angled portion 70 is perpendicular to the base 60. The angled portion 70 secures the block 34 in position in the recess 32 to enable the fastener 38 to pass through the base 60 and block 34 and into the slot 36. The angled portion 70 includes a pair of arms 72 that project outwardly towards the walls 26. Thus, a cutout 74 is formed at the lateral sides of the angled portions 70. The cutout 74 enables the tabs 50 to be received in the cutouts 74. Thus, the arms 72 are positioned on the bottom of the tabs 50 while the base 60 includes a portion positioned on top of the tab 50. Thus, as seen in FIG. 3B, the tabs 50 are sandwiched between the base 60 and locking portion arms 72. This prohibits up and down tipping or pitch movement of the terminal 14 once it is installed in the terminal block 12.

Turning to FIG. 5, another embodiment illustrates the arm 72 with a detent 74. The detent 74 registers with a recess 76 in the tabs 50 to position and lock the terminal 14 onto the tabs 50.

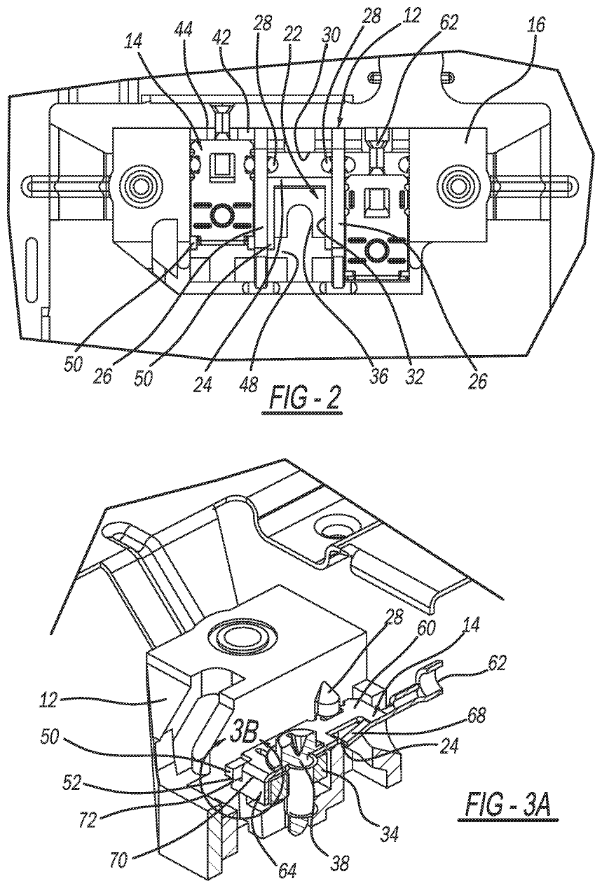

During insulation, the terminal 14 is positioned in the terminal block 12 as illustrated on the right hand side of FIG. 2. The terminal 14 is slid rearwardly into the position illustrated on the left side of FIG. 2. As this this occurs, due to the gap between the lock members 28 and floor 24, the terminal 14 slides underneath of the lock members 28 securing the terminal 14 against lateral sliding movement. Also, the finger 66 projects below the floor and will contact the wall of the floor to prohibit forward longitudinal sliding movement during assembly of the terminal 14 to the terminal block 12. As the terminal 14 is slid towards the rear wall 42, the arms 72 slide under the tabs 50 locking the front of the terminal 14 with the terminal block 12. This prohibits the terminal 14 from moving up and down or in a pitch direction on the terminal block 12. Thus, the terminal 14 is secured in the terminal block 12 against three degrees of movement. The fastener 38 is then passed through the apertures in the terminal 14 and block 34 until it is secured with the terminal block slot 36 as illustrated in FIG. 3. Thus, the terminals 14 are then securely positioned on the terminal block 12 to transfer the electrical power from the wires.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A terminal block and terminal comprising:
a terminal block including a base and at least one terminal receiving area, the at least one terminal receiving area including a floor and a pair of opposing sidewalls extending substantially perpendicular to the floor to define a channel, at least one tab projects from one of the pair of opposing walls and extends toward the other walls; and
the terminal includes a base with a wire connector portion at one end and a locking mechanism at another end, the locking mechanism including a portion to receive the at least one tab so that the at least one tab is sandwiched by the locking mechanism to lock the terminal against tipping in the terminal receiving area.

2. The terminal block and terminal according to claim 1, wherein the locking mechanism portion includes a cutout to receive the at least one tab.

3. The terminal block and terminal according to claim 1, wherein the at least one tab comprises a pair of tabs, one positioned on each of the opposing walls.

4. The terminal block and terminal according to claim 3, wherein the locking mechanism portion includes a pair of cutouts for receiving the pair of tabs.

5. The terminal block and terminal according to claim 1, wherein the locking mechanism includes an angular portion angling away from the base, the angled portion including at least one arm for engaging the at least one tab.

6. The terminal block and terminal according to claim 5, wherein the at least one arm includes a detent for engaging the at least one tab.

7. A terminal block and terminal comprising:
a terminal block including a base and at least one terminal receiving area, the at least one terminal receiving area including a floor and a pair of opposing sidewalls extending substantially perpendicular to the floor to define a channel, at least one tab projects from one of the pair of opposing walls extending toward the other wall;
a pair of terminal lock members are positioned on each wall, the pair of terminal lock members oppose one another and are spaced from the floor to provide a gap to receive the terminal; and
the terminal includes a base with a wire connector portion at one end and a locking mechanism at another end, a projecting finger is adjacent the wire connector end, the projecting finger and pair of terminal lock members prevent longitudinal and lateral movement of the terminal in the terminal receiving area, the locking mechanism engages the at least one tab to prevent pitch movement of the terminal.

8. The terminal block and terminal of claim 7, wherein the locking mechanism includes a portion engaging the tab to prevent pitch movement.

9. The terminal block and terminal according to claim 8, wherein the locking mechanism portion includes a cutout to receive the at least one tab.

10. The terminal block and terminal according to claim 7, wherein the at least one tab comprises a pair of tabs, one positioned on each of the opposing walls.

11. The terminal block and terminal according to claim 10, wherein the locking mechanism portion includes a pair of cutouts for receiving the pair of tabs.

12. The terminal block and terminal according to claim 7, wherein the locking mechanism includes an angular portion angling away from the base, the angled portion including at least one arm for engaging the at least one tab.

13. The terminal block and terminal according to claim 12, wherein the at least one arm includes a detent for engaging the at least one tab.

14. A terminal block and terminal comprising:
a terminal block including a base and a plurality of terminal receiving areas, each of the plurality of terminal receiving areas include a floor and a pair of opposing sidewalls extending substantially perpendicular to the floor to define a channel, at least one tab projects from one of the pair of opposing walls extending toward the other wall;
a pair of terminal lock members are positioned on each wall, the pair of terminal lock members oppose one another and are spaced from the floor to provide a gap to receive the terminal; and
the terminal includes a base with a wire connector portion at one end and a locking mechanism at another end, and a projecting finger adjacent the wire connector end, the projecting finger and pair of terminal lock members prevent longitudinal and lateral movement of the terminal in the terminal receiving area, and the locking mechanism engages the tab to prevent up and down movement of the terminal.

15. The terminal block and terminal of claim 14, wherein the locking mechanism includes a portion engaging the tab to prevent pitch movement.

16. The terminal block and terminal according to claim 15, wherein the locking mechanism portion includes a cutout to receive the at least one tab.

17. The terminal block and terminal according to claim 14, wherein the at least one tab comprises a pair of tabs, one positioned on each of the opposing walls.

18. The terminal block and terminal according to claim 17, wherein the locking mechanism portion includes a pair of cutouts for receiving the pair of tabs.

19. The terminal block and terminal according to claim 14, wherein the locking mechanism includes an angular portion angling away from the base, the angled portion including at least one arm for engaging the at least one tab.

20. The terminal block and terminal according to claim 19, wherein the at least one arm includes a detent for engaging the at least one tab.
